(19) United States
(12) Patent Application Publication
(10) Pub. No.: US 2010/0028551 A1
(43) Pub. Date: Feb. 4, 2010

(54) METHOD FOR FORMING AN INORGANIC COATED LAYER HAVING HIGH HARDNESS

(76) Inventors: Woo-Jae Lee, Incheon (KR); Jeong-Hoon Lee, Incheon (KR); Woo-Chang Song, Gangwon-do (KR)

Correspondence Address: LADAS & PARRY LLP, 224 SOUTH MICHIGAN AVENUE, SUITE 1600, CHICAGO, IL, 60604, US

(21) Appl. No.: 12/516,379

(22) PCT Filed: Nov. 28, 2007
(86) PCT No.: PCT/KR07/06045

§ 371 Date: May 27, 2009

(30) Foreign Application Priority Data
Nov. 28, 2006 (KR) 10-2006-0118129
Nov. 20, 2007 (KR) 10-2007-0118638

(51) Int. Cl. B05D 1/04; B05D 3/00

(52) U.S. Cl. 427/458; 427/560

(57) ABSTRACT

Provided is a method for forming a high-hardness inorganic coating layer, which is capable of providing a coating layer having abrasion resistance, chemical resistance, contamination resistance, high hardness and non-flammability on a surface of a metal or non-ferrous metal substrate at room temperature. The method comprises cleaning a substrate surface to remove impurities; subjecting a substrate surface to ultrasonic cleaning; preparing a high-hardness inorganic coating composition; coating the substrate surface with the high-hardness inorganic coating composition to form a high-hardness coating layer; drying the high-hardness coating layer; and heating the substrate at a temperature of 250 to 27O0C to cure the high-hardness coating layer.

### TECHNICAL FIELD

The present invention relates to a method for forming a high-hardness inorganic coating layer, which is capable of providing a coating layer having abrasion resistance, chemical resistance, contamination resistance, high hardness and non-flammability on a surface of a metal or non-ferrous metal substrate at room temperature.

### BACKGROUND ART

Generally, conventional coating has been carried out involving sandblasting of a substrate, preheating of the substrate to a temperature of 40 to 60° C., enamel-coating and fluoride-coating of the metal or non-ferrous metal substrate surface and heated-air drying of the coating layer at a high temperature of 400° C. to 850° C. Therefore, the conventional coating method suffers from disadvantages of high process temperature and large energy consumption with a heavy burden of production costs.

Furthermore, when the metal or non-ferrous metal surface is polluted with various contaminants since the coating layer contains organic materials and the metal or non-ferrous metal surface is made of a hydrophobic material, such contaminants are not readily removed and therefore should be eliminated with an organic solvent or the like. Application of the organic solvent to remove contaminants may contribute to secondary environmental contamination. Furthermore, the organic coating raises various problems such as release of environmentally hazardous substances upon coating, life-threatening risk due to generation of poisonous gases upon the occurrence of a fire, and primary cause for environmental contamination.

Therefore, there is a need for development of a coating method which is in-expensive and environmentally friendly.

### DISCLOSURE OF INVENTION

### Technical Problem

Therefore, the present invention has been made in view of the above problems, and it is an object of the present invention to provide a method for forming a high-hardness inorganic coating layer, which is applicable to both metal and non-ferrous metal substrates and is capable of simply achieving a coating process at room temperature without a preheating step, and which includes heated-air drying of a coating layer formed of a high-hardness inorganic coating agent on the substrate surface at a temperature of 270° C.±20° C., thus causing no risk of poisonous gas production due to non-flammability even upon the occurrence of a fire and consequently is excellent as an environmentally-friendly material.

### Technical Solution

In accordance with an aspect of the present invention, the above and other objects can be accomplished by the provision of a method for forming a high hardness inorganic coating layer, comprising the step of, ultrasonic cleaning of a substrate surface, preparing a high hardness inorganic coating composition, coating layer forming to the substrate surface with the high hardness inorganic coating composition, wherein the coating layer have a high hardness natural air drying the high hardness coating layer and heated air drying the high hardness coating layer. The ultrasonic cleaning step may be carried out at an ultrasonic frequency of 28 to 48 kHz.

The composition preparing step may include dispersing the high-hardness inorganic coating agent at a rate of 150 to 400 rpm, and stirring the dispersed mixture at a rate of 100 to 300 rpm to remove bubbles (defoaming step).

In the coating layer-forming step, formation of the coating layer may be carried out by any method selected from electrostatic spray, dipping, ultrasonic coating, vacuum deposition, and coating layer formation under nitrogen gas atmosphere.

In the coating layer-forming step, a thickness of the high-hardness inorganic coating layer may be in a range of 1 to 35 □.

The step of forming the high-hardness coating layer may be repeated two or more times.

The natural-air drying step may be carried out at a temperature of 20 to 30° C. for 10 min or more.

The heated-air drying step may be carried out at a temperature of 270±20° C.

The heated-air drying step may be carried out at a temperature elevation rate of 4 to 6° C./min.

The secondary drying step may be carried out at a temperature decrement rate of 4 to 6° C./min.

The substrate may be selected from metals, non-ferrous metals, ceramic, stones, and tiles.

The detergent used in the ultrasonic cleaning step may be a water-soluble detergent containing inorganic salts.

The coating layer-forming method may further comprise dipping and steam cleaning steps to remove oil content present on the substrate surface.

The high-hardness inorganic coating composition may comprise the molten vitreous frit material of a silicate or modified-silicate compound, and particulate silica.

The high-hardness inorganic coating composition may further comprise at least one material selected from oxides, hydroxides and phosphates of metals.

### Advantageous Effects

As will be illustrated hereinafter, according to the present invention, it is possible to form an inorganic coating layer which is capable of being simply coated at room temperature, is inexpensive owing to a low drying temperature and consequent low energy consumption, and is environmentally friendly due to no production of poisonous gases.

### BEST MODE FOR CARRYING OUT THE INVENTION

Examples of the substrate that can be used in the present invention may include metal and non-ferrous metal materials, and various other materials which will withstand the heated-air drying temperatures without deformation or degradation of the substrate, such as ceramic materials, stones, and tiles.

The present invention provides a method for forming a high-hardness inorganic coating layer, comprising subjecting a substrate surface to ultrasonic cleaning, preparing a high-hardness inorganic coating composition, coating the substrate surface with the high-hardness inorganic coating composition to form a high-hardness coating layer, subjecting the high-hardness coating layer to natural-air drying, and subjecting the high-hardness coating layer to heated-air drying.

The ultrasonic cleaning step is carried out by soaking the substrate in an ultrasonic tank which was filled with a water-soluble detergent, and generating ultrasonic waves to thoroughly clean the substrate surface including minute parts thereof. The ultrasonic cleaning may be preferably carried out at a frequency of 28 to 48 kHz.

The ultrasonic cleaning may be carried out using a water-soluble detergent containing inorganic salts. By using the inorganic salt-containing water soluble detergent, it is possible to increase adhesion with an inorganic coating layer which is a coating layer formed on a surface of the substrate, simultaneously with formation of a high-hardness coating layer.

The method of the present invention may further comprise dipping and steam cleaning steps to remove oil content and impurities, prior to the ultrasonic cleaning step. These additional steps may be applied when there are impurities, even though they are not necessary when the substrate surface is clean, that is free of impurities.

The dipping and steam cleaning are carried out to remove a variety of oil contents such as mineral synthetic oil adhered to the substrate surface. For example, the substrate is placed in the tank and then dipped and washed in a solvent. Alternatively, the solvent is evaporated and the resulting vapors are condensed and allowed to flow onto the substrate surface. In this manner, the oil content and impurities are completely cleared by the flowing condensed water. Cleaning via the vapor condensation can reduce the production time because a subsequent process can be carried out without the need for a separate drying step, as the substrate is dried immediately after it is taken from the tank.

Preparation of the high-hardness inorganic coating agent is a step for coating the high-hardness inorganic coating agent on a surface of the substrate, and includes stirring the high-hardness inorganic coating agent, followed by defoaming.

The high-hardness inorganic coating agent may comprise silicate or modified silicate frits, inorganic fillers, particulate silica-containing materials, materials containing multivalent metal oxides, hydroxides or phosphates, non-ionic surfactants, alumina, dispersants, and other additives. Such a high-hardness inorganic coating agent exhibits high hardness, antibacterial activity, water-resistance, chemical resistance and non-flammability, and may effectively form a coating layer exhibiting very superior adhesion with the substrate.

The preparation step of the high-hardness inorganic coating agent according to the present invention includes stirring and defoaming of the high-hardness inorganic coating agent.

The stirring rate is preferably in a range of 150 to 400 rpm. If the stirring rate is lower than 150 rpm, this may lead to insufficient mixing of the composition. However, the stirring rate exceeding 400 rpm provides no significant difference in the stirring performance. Therefore, the stirring rate is set to the above-specified range of 150 to 400 rpm.

Thereafter, formation of the coating layer is carried out which involves coating of the thus-prepared high-hardness inorganic coating agent on the surface of substrate which was previously cleaned. For this purpose, the high-hardness inorganic coating agent is spray-coated on the substrate surface to thereby form a high-hardness inorganic coating layer.

Alternatively, coating of the high-hardness inorganic coating agent may be carried out by application of various methods such as electrostatic spray, dipping, ultrasonic coating, vacuum deposition, a coating method using nitrogen gas, and the like.

The high-hardness inorganic coating layer is formed to a thickness of 1 to 35 □. If the coating thickness is less than 1 □, the hardness of the high-hardness inorganic coating layer is significantly lower. On the other hand, if the coating thickness is more than 35 □, light transmittance becomes lower, so it is impossible to obtain desired properties of the high-hardness inorganic coating layer.

In the present invention, the step of forming the coating layer on the substrate surface may be repeated two or more times. In this case, a first coating layer is formed and subjected to natural-air drying, and then a second coating layer is formed thereon.

When coating is repeated several times, it is possible to form a coating layer having a desired thickness, dense coating and high surface smoothness, but there is the risk of cracking of the coating layer in the heating step, due to incomplete drying of the previous step.

When particulate silica or amorphous silica is added to the coating agent used in the present invention, such a silica component is completely dispersed at room temperature in a silicate or modified-silicate solution to thereby neutralize the entire coating agent solution. Furthermore, when the coating layer is formed through the drying process, silica particles migrate and fix to the coating layer surface during the drying and de-hydrating processes, which consequently leads to fixation of alkali metal components within a regular tetrahedral structure of the silica to thereby prevent release of the alkali metal components to the coating layer surface. As a result, a high-hardness inorganic coating layer is formed which has a coating surface with no occurrence of coat bleaching due to the alkali metal release, in conjunction with a superior water-resistance.

The drying step of the high-hardness inorganic coating layer is divided into a natural-air drying step and a heated-air drying step.

The natural-air drying step is intended primarily for removal of moisture in the coating layer, and is carried out at a temperature of 20 to 30° C. for 10 min or more. If the drying temperature is lower than 10° C., this may result in a prolonged drying time and insufficient removal of moisture, which will have adverse effects on the adhesion and hardness of the coating layer. On the other hand, if the drying temperature is higher than 30° C., this may result in deformation of the coating layer due to a rapid increase in temperature, and cracking of the coating layer during the heated-air drying step.

The heated-air drying step is carried out at a temperature of 270° C.±20° C. and is intended for complete drying of the high-hardness inorganic coating layer. For this purpose in the present invention, the substrate which passed the natural-air drying step is introduced into a drying oven. Then, the maximum temperature inside the drying oven is elevated to a range of 270° C.±20° C., followed by drying of the substrate. If the maximum temperature is less than 250° C., this may result in insufficient drying and poor physical properties of the coating layer. On the other hand, if the maximum temperature is higher than 290° C., this may result in cracking and swelling of the coating layer, which would compromise physical properties of the high-hardness inorganic coating layer.

In the present invention, a temperature increment is very important in association with internal temperature elevation of the drying oven. It is reasonable to increase the drying oven temperature at a temperature elevation rate of 4 to 6° C./min. If the temperature elevation rate is less than 4° C./min, this may result in an excessively long drying time, thus imposing an economic burden. On the other hand, if the temperature elevation rate is higher than 6° C./min, this may result in physical property deterioration, cracking and swelling of the coating layer, due to a rapid increase in temperature.

Further, according to the present invention, when it is desired to lower the oven temperature from the maximum temperature, the temperature is slowly decreased. That is, if the oven temperature is rapidly cooled as mentioned above, this may result in poor physical properties of the coating layer, occurrence of coating cracking, and adverse effects on the adhesion of the coating layer.

### MODE FOR THE INVENTION

### EXAMPLES

Now, the present invention will be described in more detail with reference to the following Examples. These examples are provided only for illustrating the present invention and should not be construed as limiting the scope and spirit of the present invention.

### Example 1

First, impurities and oil content present on a surface of a metal or non-ferrous metal substrate were completely removed by a cleaning process. Then, a high-hardness inorganic coating agent was prepared. Next, the thus-prepared high-hardness inorganic coating agent was coated on the metal or non-ferrous metal substrate surface. For this purpose, a coating having a thickness of about 3 □ was formed on the substrate surface, followed by natural-air drying at room temperature for 20 min. Next, the resulting coating layer was placed in a far-infrared drying oven which was then elevated at a rate of 4 to 6° C./min to reach a maximum temperature of 290° C. and thereafter slowly cooled at the same rate.

### Example 2

First, impurities and oil content present on a surface of a metal or non-ferrous metal substrate were completely removed by a cleaning process. Then, a high-hardness inorganic coating agent was prepared. Next, the thus-prepared high-hardness inorganic coating agent was coated on the metal or non-ferrous metal substrate surface. For this purpose, a primary coating having a thickness of about 3 □ was formed on the substrate surface, followed by natural-air drying at room temperature for 20 min. Next, a secondary coating having a thickness of about 3 □ was formed thereon, followed by natural-air drying. This procedure was repeated four times to thereby form a coating layer having a thickness of about 12 □. This was followed by natural-air drying at room temperature for 20 min. Thereafter, the resulting coating layer was placed in a far-infrared drying oven which was then elevated at a rate of 4° C./min to reach a maximum temperature of 290° C. and thereafter slowly cooled at the same rate.

### Comparative Example 1

A substrate of Example 1 was not coated.

### Comparative Example 2

A coating layer of a conventional fluororesin was formed on a substrate of Example 1.

In this manner, a high-hardness inorganic coating layer was finished using a high-hardness inorganic coating agent. The test results for the coating layer are set forth in Table 1 below.

TABLE 1
Test results
Comp. Ex. 2

4H
15
100/100
Non-brittle
Discolored
Non-cleaned
Poisonous gases generated
Scratch found

### INDUSTRIAL APPLICABILITY

The present invention enables formation of an inorganic coating layer which is capable of being simply coated at room temperature, is inexpensive due to a low drying temperature and consequent low energy consumption, and is environmentally friendly due to no evolution of poisonous gases.

1. A method for forming a high-hardness inorganic coating layer, comprising the step of:
Ultrasonic cleaning of a substrate surface;
preparing a high-hardness inorganic coating composition;
coating layer forming to the substrate surface with the high-hardness inorganic coating composition, wherein the coating layer have a high-hardness;
natural-air drying the high-hardness coating layer; and
heated-air drying the high-hardness coating layer.

2. The method according to claim 1, wherein the ultrasonic cleaning step is carried out at an ultrasonic frequency of 28 to 48 kHz.

3. The method according to claim 1, wherein the composition preparing step includes dispersing the high-hardness inorganic coating agent at a rate of 150 to 400 rpm, and stirring the dispersed mixture at a rate of 100 to 300 rpm to remove bubbles.

4. The method according to claim 1, wherein the formation of the coating layer in the coating layer-forming step is carried out by any method selected from electrostatic spray, dipping, ultrasonic coating, vacuum deposition, and coating layer formation under nitrogen gas atmosphere.

5. The method according to claim 1, wherein the high-hardness inorganic coating layer in the coating layer-forming step has a thickness of 1 to 35 □.

6. The method according to claim 1, wherein the step of forming the high-hardness coating layer is repeated two or more times.

7. The method according to claim 1, wherein the natural-air drying step is carried out at a temperature of 20 to 30? for 10 min or more.

8. The method according to claim 1, wherein the heated-air drying step is carried out at a temperature of 270 20?.

9. The method according to claim 1, wherein the heated-air drying step is carried out at a temperature elevation rate of 4 to 6° C./min.

10. The method according to claim 1, wherein the secondary drying step is carried out at a temperature decrement rate of 4 to 6° C./min.

11. The method according to claim 1, wherein the substrate is selected from a metal, a non-ferrous metal, a ceramic, a stone and a tile.

12. The method according to claim 1, wherein the detergent used in the ultrasonic cleaning step is a water-soluble detergent containing inorganic salts.

13. The method according to claim 1, further comprising dipping and steam cleaning steps to remove oil content present on the substrate surface.

14. The method according to claim 1, wherein the high-hardness inorganic coating composition comprises:
a molten vitreous frit material of a silicate or modified-silicate compound; and particulate silica.

15. The method according to claim 14, wherein the high-hardness inorganic coating composition further comprises at least one material selected from oxide, hydroxide and phosphate of a metal.
